(19) United States
(12) Patent Application Publication
(10) Pub. No.: US 2016/0034513 A1
(43) Pub. Date: Feb. 4, 2016

(54) METHOD TO FILTER AND GROUP TREE STRUCTURES WHILE RETAINING THEIR RELATIONSHIPS

(71) Applicant: Potix Corporation, Taipei City (TW)

(72) Inventor: Ming-Shia Yeh, Hsinchu County (TW)

(21) Appl. No.: 14/601,237

(22) Filed: Jan. 21, 2015

Related U.S. Application Data
(60) Provisional application No. 62/031,165, filed on Jul. 31, 2014.

(51) Int. Cl. G06F 17/30

(52) U.S. Cl. CPC G06F 17/30345; G06F 17/30312

(57) ABSTRACT

A method for filtering tree nodes and a method for grouping tree nodes are provided. The filtering method filters a plurality of nodes of at least one source tree according to a criterion. The result of the filtering includes at least one target tree and each target tree is a subset of one of the source trees. The grouping method splits a plurality of nodes of at least one source tree into a plurality of groups according to a criterion. Each group includes at least one target tree and each target tree is a subset of one of the source trees. The hierarchy of at least one source tree is preserved in the target trees after the filtering and/or the grouping.

### CROSS-REFERENCE TO RELATED APPLICATION

This application claims the priority benefits of U.S. provisional application Ser. No. 62/031,165, filed on Jul. 31, 2014. The entirety of the above-mentioned patent application is hereby incorporated by reference herein and made a part of this specification.

### BACKGROUND OF THE INVENTION

1. Field of the Invention

The present invention relates to a method in filtering and grouping tree structures whilst retaining the relationship between the nodes in the trees.

2. Description of the Related Art

Tree structures are very common in modern operating systems. For example, files in a file system and bookmarks in a web browser are often organized into tree structures for purposes of browsing and managing. There are application programs that provide functions for filtering or grouping the nodes of a tree structure into a list. However, the said list does not preserve the parent/child relationship between the nodes in the tree structure.

### SUMMARY OF THE INVENTION

Accordingly, the present invention is directed to a method of transforming one or more source tree structures to one or more target tree structures while preserving the source trees' hierarchy in the target trees.

According to an embodiment of the present invention, a method for filtering tree nodes is provided. The method filters a plurality of nodes of at least one source tree according to a criterion. The result of the filtering includes at least one target tree and each target tree is a subset of one of the source trees. The hierarchy of at least one source tree is preserved in at least one target tree.

According to another embodiment of the present invention, a method for grouping tree nodes is provided. The method splits a plurality of nodes of at least one source tree into a plurality of groups according to a criterion. Each group includes at least one target tree and each target tree is a subset of one of the source trees. The hierarchy of at least one source tree is preserved in the target trees.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram showing a source tree according to an embodiment of the present invention.

FIG. 1B and FIG. 1C are schematic diagrams showing target trees according to an embodiment of the present invention.

FIG. 2A is a schematic diagram showing a source tree according to an embodiment of the present invention.

FIG. 2B and FIG. 2C are schematic diagrams showing target trees and groups according to an embodiment of the present invention.

FIG. 3A is a schematic diagram showing a source tree according to an embodiment of the present invention.

FIG. 3B is a schematic diagram showing target trees according to an embodiment of the present invention.

FIG. 3C is a schematic diagram showing target trees formed by a grouping method according to an embodiment of the present invention.

FIG. 4, FIG. 5 and FIG. 6 are schematic diagrams showing active tasks organized into trees according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

An embodiment of the present invention provides a method of transforming one or more source tree structures to one or more target tree structures while preserving the source trees' hierarchy in the target trees. The aforementioned transformation may include filtering and/or grouping the nodes of the one or more source tree structures.

The term “source tree” is used to describe a tree structure that is subject to a method of transformation. The term “target tree” refers to the result of this transformation. A transformation may be the act of filtering and/or grouping.

The terms “parent” and “child” are used to describe the hierarchical relationship between nodes in a tree structure. A parent node may have one or more child nodes. Every node, except the root, has exactly one parent node. Let a node Z be the sole parent of a node Y, and a node Y be the sole parent of node X. We define a 1^{st} generation parent-child relationship between Z and Y; while we say node Z and node X to have a 2^{nd} generation parent-child relationship. We generalize this notion of parent-child relationship to any number of generations. All 1^{st} generation parent-child relationships will be called an “explicit” parent-child relationship while any number of generations greater than 1 will be called an “implicit” parent-child relationship.

In the event that one or more parent nodes are removed as a result of the said transformation, an implicit parent-child relationship is promoted to an explicit parent-child relationship. The hierarchy of a source tree is said to be preserved in the target tree when all explicit and implicit parent-child relationships stay true after the transformation.

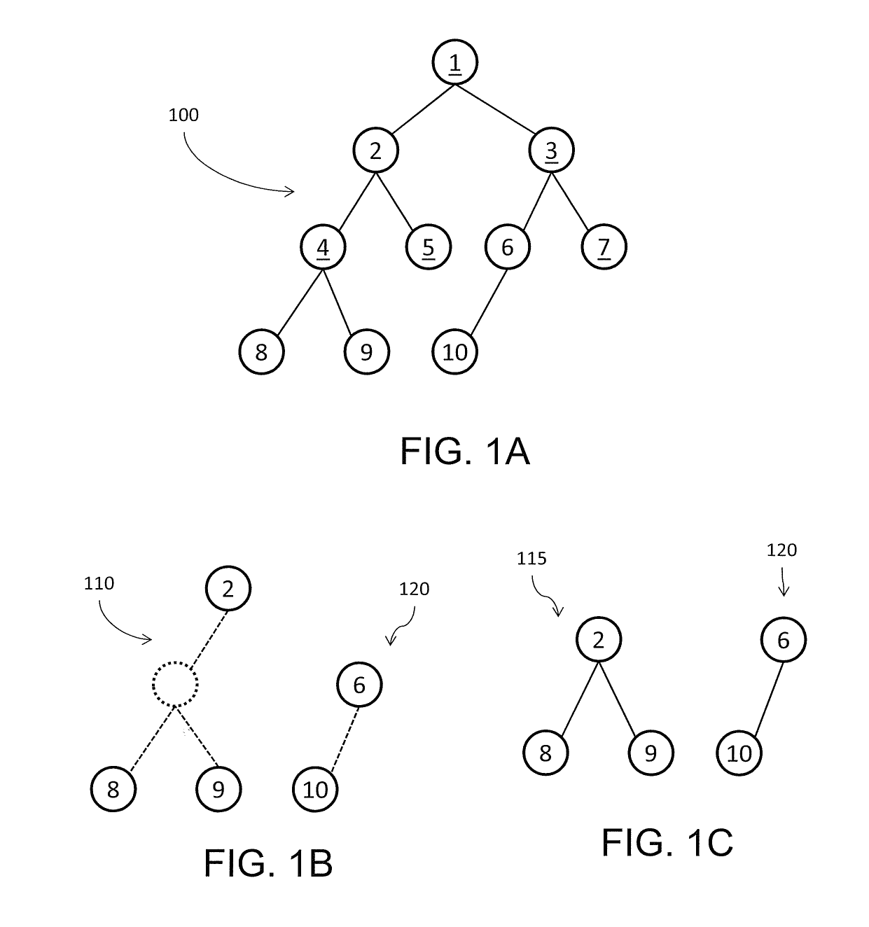

FIG. 1A is a schematic diagram showing a source tree 100 according to an embodiment of the present invention. In the following descriptions, the term “tree structure” may be abbreviated as “tree” for brevity. In this embodiment, the present invention provides a method for filtering the nodes of a tree. For example, source tree 100 includes a plurality of nodes. Nodes 2, 6 and 8-10 are not underlined, while nodes 1, 3-5 and 7 are underlined. Each node may represent a physical object or an abstract object, such as a file, an active task or an employee. Each node may include one or more pieces of data or information depending on the application.

The method may filter the nodes of source tree 100 according to pre-set criterion or criteria. For example, assume the criterion picks the nodes that are not underlined. FIG. 1B shows the result of the filtering. The result includes target trees 110 and 120 that are subsets of source tree 100. Node 2 becomes the root node of target tree 110 because the parent of node 2 (namely, node 1) does not match the filtering criterion. Similarly, node 6 becomes the root node of target tree 120 because the parents of node 6 (namely, nodes 1 and 3) do not match the filtering criterion. The hierarchy of source tree 100 is still preserved in target trees 110 and 120. The dotted circle in target tree 110 represents node 4 that does not match the criteria.

Next, the method may rebuild target tree 110 based on the hierarchy of the nodes in the source tree 100. FIG. 1C shows the result of the rebuilding. Since node 4 is filtered out and does not actually exist in target tree 110, the method may arrange nodes 8 and 9 to be the child nodes of node 2. The target tree 115 in FIG. 1C is the rebuilt version of target tree 110. In other words, the implicit parent-child relationship among nodes 2, 8 and 9 is promoted to an explicit parent-child relationship, Target tree 120 does not need rebuilding because no node is filtered out like node 4 is in target tree 110.

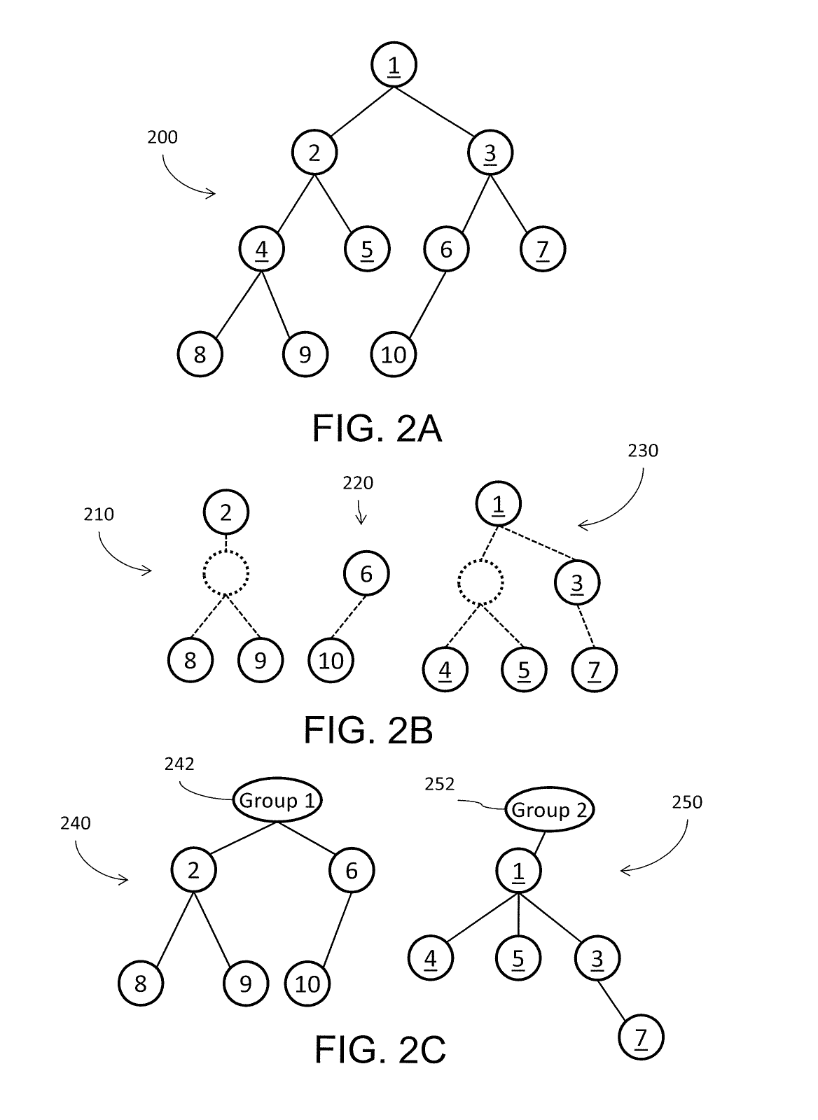

FIG. 2A is a schematic diagram showing a source tree 200 according to an embodiment of the present invention. In this embodiment, the present invention provides a method for grouping the nodes of a source tree. The method may split the nodes of a source tree into different groups based on pre-set criterion or criteria. For example, FIG. 2B shows the result of splitting the nodes of the source tree 200 into two groups. The result includes target trees 210, 220 and 230 which are subsets of source tree 200. The hierarchy of source tree 200 is still preserved in target trees 210, 220 and 230. Target trees 210 and 220 consist of the nodes matching the criterion for the first group. Target tree 230 consists of nodes matching the criterion for the second group. The dotted circle in target tree 210 represents node 4 that does not match the criterion for the first group. The dotted circle in target tree 230 represents node 2 that does not match the criterion for the second group.

Next, the method may rebuild target trees 210 and 230 based on the original hierarchy of the nodes in the source tree 200. FIG. 2C shows the result of the rebuilding. Since node 4 is filtered out and does not actually exist in target tree 210, the method may promote the implicit parent-child relationship among nodes 2, 8 and 9 to an explicit parent-child relationship, as shown in target tree 240 in FIG. 2C. Similarly, the method may promote the implicit parent-child relationship among nodes 1, 4 and 5 to an explicit parent-child relationship, as shown in target tree 250 in FIG. 2C. Target tree 220 does not need rebuilding.

The method may add a new root node representing a group itself to bind the target trees of the group together. As shown in FIG. 2C, the method adds a new root node 242 representing the first group on top of target trees 210 and 220 to faun the target tree 240. The original root nodes 2 and 6 become the child nodes of the new root node 242. Similarly, the method adds another new root node 252 representing the second group on top of target tree 230 to form target tree 250. The original root node 1 becomes a child node of the new root node 252. The nodes 242 and 252 are also known as group root nodes. In FIG. 2C, each group is a single tree.

The grouping method above may be further applied to the result of the grouping repeatedly to have nested groups. No matter how many levels of grouping, the result is still a collection of tree structures. By adding one or more group root node to bind the target trees together, the result of repeated grouping may still be a single tree structure.

In an embodiment of the present invention, the filtering method and the grouping method may be applied to the same tree structure. In other words, a tree structure may go through one or more transformations.

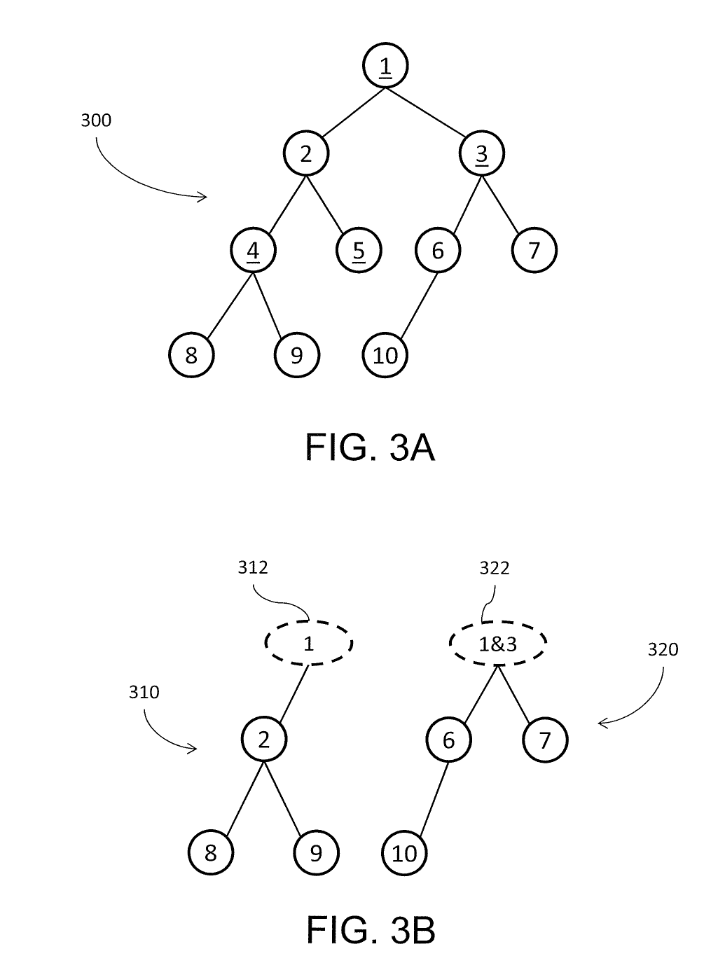

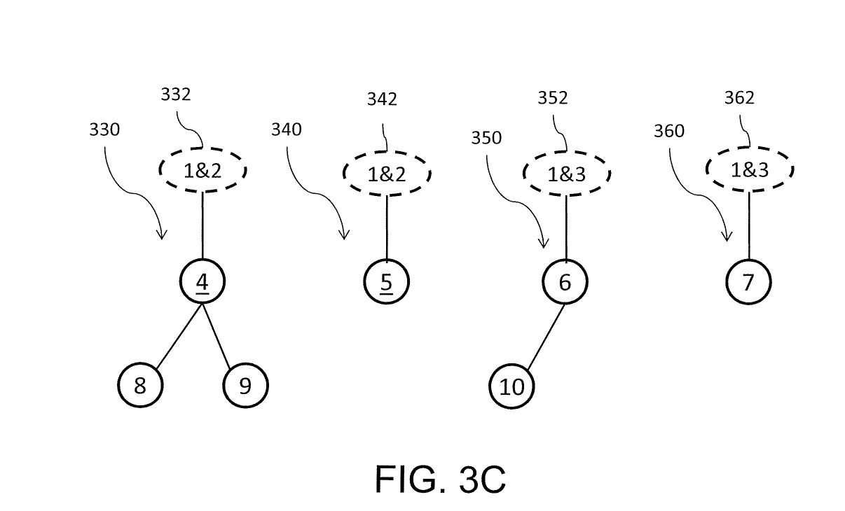

As described above, a tree in the result of filtering or grouping may be rebuilt. Sometimes the information of a node might be hard to understand after such rebuilding because the parent node might not be available. For example, FIG. 3A is a schematic diagram showing a source tree 300 according to an embodiment of the present invention. FIG. 3B shows the result of a filtering followed by a rebuilding performed on the source tree 300. The result includes the target trees 310 and 320. In this embodiment, node 2 may depend on the contextual information contained in node 1 to stay meaningful. In the event that node 1 is lost after a transformation, node 2 would no longer convey its meaning.

This problem can be solved by introducing virtual tree nodes to carry the contextual information of missing explicit or implicit parent nodes after a transformation. As shown in FIG. 3B, the virtual node 312 is added as the parent node of node 2 to carry the contextual information in the missing node 1. Similarly, the virtual node 322 is added as the parent node of nodes 6 and 7 to carry the contextual information of the missing nodes 1 and 3. The contextual information stored in a virtual node may be anything depending on the application. For example, the contextual information may be a file path or a hypertext link. The contextual information in a virtual node may be abbreviated or compressed to save storage space.

In another embodiment, the present invention provides a method for grouping the nodes of a tree by their level. Take the source tree 300 in FIG. 3A for example. The group method may split the nodes of source tree 300 into multiple groups based on the levels of the nodes in source tree 300. The level of the root node of a tree is one. The level of the child nodes of the root node is two. The level of a child node is the level of its parent node plus one.

For example, target trees 330, 340, 350 and 360 in FIG. 3C are the result of grouping the nodes of source tree 300 whose levels are greater than two. In other words, target trees 330, 340, 350 and 360 are formed by removing each node from source tree 300 whose level is smaller than or equal to two. The nodes in target trees 330, 340, 350 and 360 retain the hierarchy in the source tree 300.

After grouping by level, virtual tree nodes may be introduced to carry the contextual information of the missing parent nodes. As shown in FIG. 3C, the virtual node 332 is added into target tree 330 to become the root node of target tree 330. The virtual node 332 includes the information of nodes 1 and 2 because nodes 1 and 2 are the parent nodes of node 4 in the source tree 300 in which they were removed after the grouping. Similarly, virtual nodes 342, 352 and 362 are added into the target trees 340, 350 and 360 to become the root nodes of target trees 340, 350 and 360, respectively. Virtual nodes 342, 352 and 362 include information of the parent nodes of nodes 5, 6 and 7, respectively.

When a tree contains too many levels, it can be difficult to browse and manage on a small screen or on mobile electronic devices such as a smart phone or a tablet computer. The aforementioned method of grouping by level extracts high-level sub-trees from the source tree, thus making it easier to browse and manage.

In another embodiment of the present invention, filtering criteria may be applied to the grouping to filter out at least one tree among target trees 330, 340, 350 and 360.

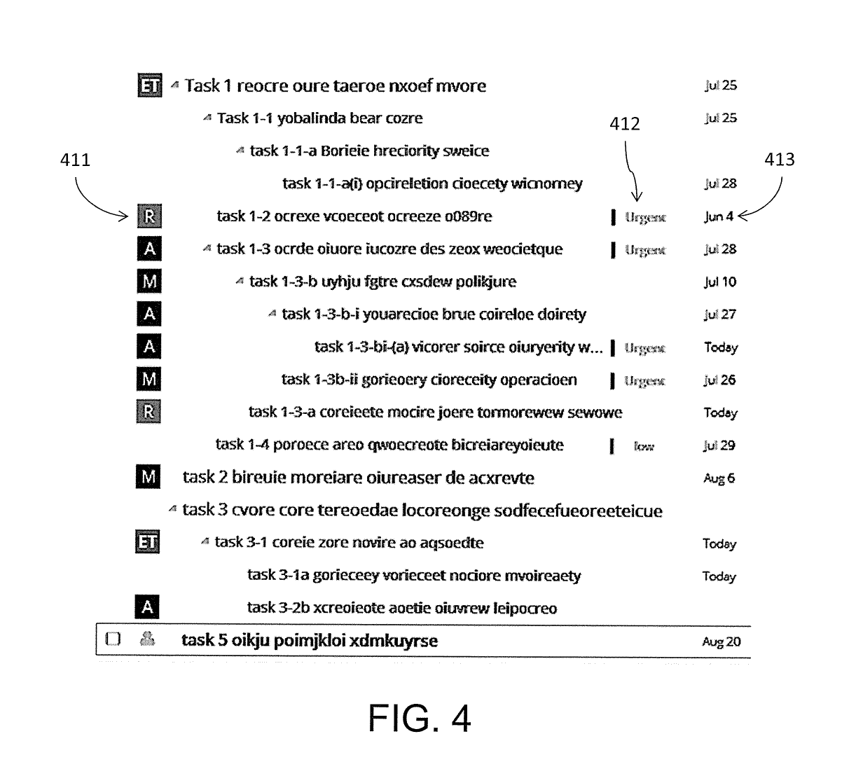

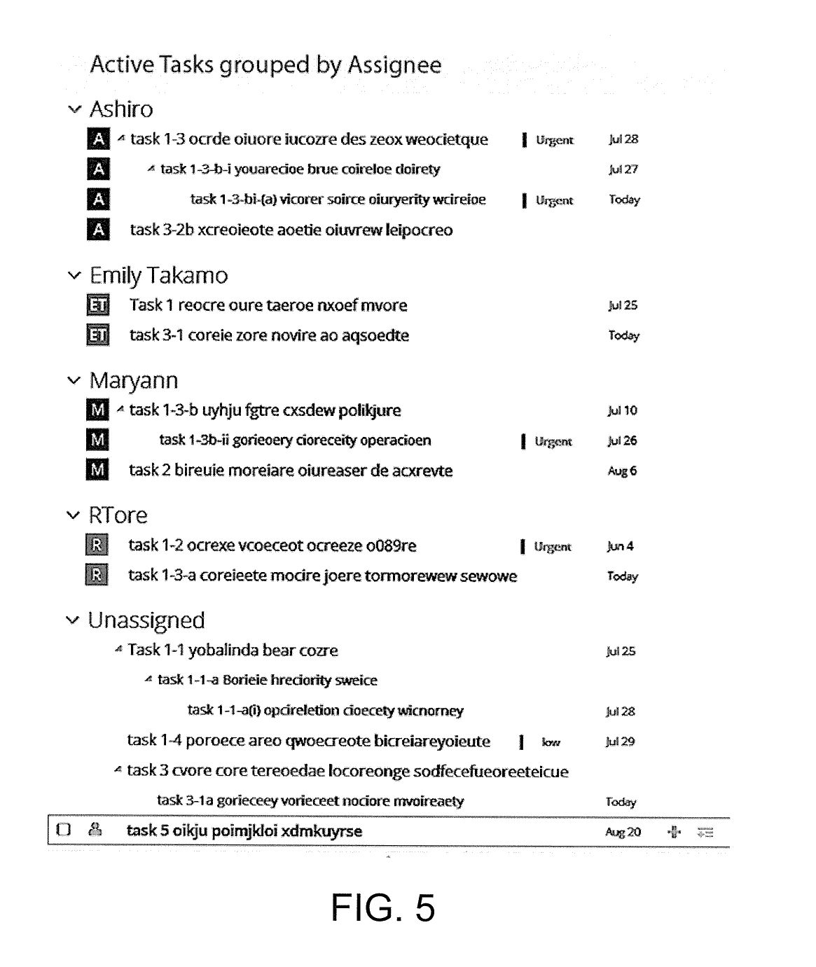

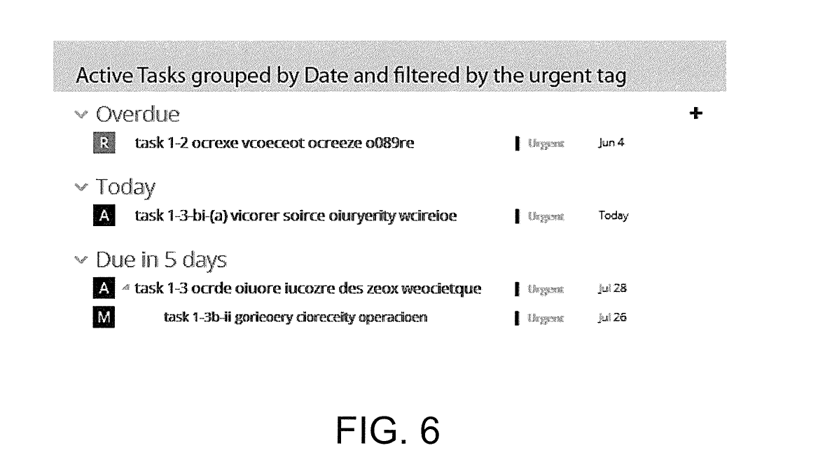

FIG. 4 is a schematic diagram showing active tasks organized into a tree structure according to an embodiment of the present invention. The tree view in FIG. 4 may be displayed by an application installed on an electronic device such as a smart phone, a tablet computer, a notebook computer, or a personal computer. The electronic device may include a processor, a display, and a storage device. The storage device stores the application and the operating system of the electronic device. The processor executes the application and the operating system. The display displays the tree view in FIG. 4. In another embodiment of the present invention, the electronic device may further include a network interface for receiving the data or the information stored in the tree nodes from a network or a server. In another embodiment of the present invention, the electronic device may further include a scanner for obtaining the data or the information stored in the tree nodes from printed documents.

In FIG. 4, each row contains an active task. The indents of the active tasks represent the hierarchy of the tree structure. For example, active task 1 is the parent node of active task 1-1. Active task 1-1 is the parent node of active task 1-1-a. Active task 1-1-a is the parent node of active task 1-1-a(i). An active task may have an associated icon representing the assignee of the active task, such as the icon 411. An active task may have an associated label representing the priority level of the active task, such as the label 412. An active task may have an associated date, such as the date 413.

FIG. 5 is a schematic diagram showing the active tasks in FIG. 4 grouped according to the assignees of the active tasks. Each group corresponds to an assignee. Unassigned active tasks form an independent group. The hierarchy of the source tree in FIG. 4 is still preserved in each group in FIG. 5.

FIG. 6 is a schematic diagram showing the active tasks in FIG. 4 filtered and grouped. The filtering picks the active tasks with the priority level of “urgent” and the grouping is based on the dates of the active tasks. Therefore, only urgent active tasks appear in FIG. 6. The first group includes the overdue urgent active tasks. The second group includes the urgent active tasks that are due today. The third group includes the urgent active tasks that are due in 5 days. The hierarchy of the source tree in FIG. 4 is still preserved in the groups in FIG. 6.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for filtering tree nodes, including:
filtering a plurality of nodes of at least one source tree according to a criterion, wherein a result of the filtering includes at least one target tree and each said target tree is a subset of a said source tree, wherein hierarchy of at least one said source tree is preserved in at least one said target tree.

2. The method of claim 1, further including:
when a said node in a said source tree is filtered out by the criterion and one of the target trees includes a parent node and a child node of the said node, rebuilding the one target tree by promoting an implicit parent-child relationship between the parent node and the child node to an explicit parent-child relationship.

3. The method of claim 1, further including:
when a said node in a said source tree is filtered out by the criterion and one of the target trees includes a child node of the said node, adding a virtual tree node carrying contextual information of the said node into the one target tree as a parent node of the child node.

4. A method for grouping tree nodes, including:
splitting a plurality of nodes of at least one source tree into a plurality of groups according to a criterion, wherein each said group includes at least one target tree and each said target tree is a subset of a said source tree, wherein hierarchy of at least one said source tree is preserved in the target trees.

5. The method of claim 4, further including:
when a said node is assigned to a said target tree and a parent node and a child node of the said node are assigned to another said target tree, rebuilding the another target tree by promoting an implicit parent-child relationship between the parent node and the child node to an explicit parent-child relationship.

6. The method of claim 4, further including:
when a said node is assigned to a said target tree and a child node of the said node is assigned to another said target tree, adding a virtual tree node carrying contextual information of the said node into the another target tree as a parent node of the child node.

7. The method of claim 4, further including:
for each said group, adding a group root node representing the group itself to bind the target trees of the group together to form a single tree.

8. The method of claim 7, wherein the original root nodes of the bound target trees become child nodes of the group root node after the group root node is added.

9. The method of claim 4, wherein the step of splitting the nodes into the groups includes:
splitting the nodes into the groups according to levels of the nodes in at least one said source tree.

10. The method of claim 9, wherein the step of splitting the nodes into the groups further includes:
only splitting the nodes whose levels are greater than a preset threshold into the groups.
